(19) United States
(12) Patent Application Publication
(10) Pub. No.: US 2012/0086203 A1
(43) Pub. Date: Apr. 12, 2012

(54) Exhaust Generator Assembly

(76) Inventor: Peter Agtuca, Auburn, WA (US)

(21) Appl. No.: 13/012,705

(22) Filed: Jan. 24, 2011

Related U.S. Application Data
(63) Continuation-in-part of application No. 12/698,914, filed on Feb. 2, 2010.
Application No. 12/698,914 is a continuation-in-part of application No. 12/228,316, filed on Aug. 11, 2008, now Pat. No. 7,969,035.
(60) Provisional application No. 60/964,404, filed on Aug. 9, 2007.

(51) Int. Cl. H02P 9/04

(52) U.S. Cl. 290/43

(57) ABSTRACT

An apparatus for generating electricity from a relatively low velocity exhaust produced by a blower on a piece of machinery. The apparatus includes a fan assembly and a generator located inside an outer housing mounted on a base. Attached to the base and extending into the outer housing is a conical tunnel with a bypass gate that selectively closes the tunnel and thereby control the flow of exhaust gas through the apparatus. The fan assembly includes a plurality of fixed vanes that extend transversely into the path of the exhaust. The ends of the vanes are attached to two side plates that rotate freely around the frame's center axis. Attached to the inside side plate is a low RPM generator that includes two rotating magnetic plates and a fixed stator disc with a plurality of coil members is formed. The apparatus includes a programmable logic controller (PLC) coupled to sensors that monitor the exhaust gas velocity delivered to the tunnel, the fan assembly's RPMs and the position of the bypass gate in the tunnel. During operation, the PLC is constantly monitors and makes adjustments to the position of the bypass gate to control the flow of exhaust gas to the fan assembly so that the maximum amount of electricity is being produced without negatively impact the machinery's performance.

This utility patent application is a continuation in part application based on the utility patent application Ser. No. 12/698,914, filed on Feb. 2, 2010 and Ser. No. 12/228,316 filed on Aug. 12, 2008 (which claims the benefit of U.S. Provisional Application No. 60/964,404 filed on Aug. 9, 2007).

### BACKGROUND OF THE INVENTION

1. Field of the Invention

This invention relates to exhaust energy recovery systems, and more particularly to such systems specifically designed to be used with exhaust systems.

2. Description of the Related Art

As shown in FIG. 1, manufacturing buildings typically have exhaust, fume, dust and hot air systems mounted on the sides or roofs of the building through which exhaust, fumes, dust and hot air produced by machinery located inside the building. Normally, the blower used with these systems are connected to a short duct that extends to an opening formed on the ceiling or on an exterior wall. An electric blower is then attached to the end of the duct that expels the exhaust gases, fume, dust, and hot air into the outside atmosphere. In some instances, the blower is located in an area where workers are located and therefore, must include a muffler to reduce noise.

The size of the blower, the size and shape of the duct, and the size and shape of the muffler are selected so that the blower expels exhaust, fumes, dust and hot air at the desired rate required by the piece of equipment. If improper ducts and mufflers used with such systems, excessive backflow pressure can be created on the blower that reduces the volume of exhaust it can handle. As a result, poisonous exhaust gases, fumes, dust and hot air can accumulate inside the building. It addition, excessive heat can build up in the blower causing it to operate inefficiently and burn out sooner than expected. Therefore, when making changes to the ducts and mufflers used with such systems it is important that one know what impact the changes may have on the blower.

In many manufacturing buildings, the large blowers on machinery operate 24 hrs a day and 7 days a week. An electric generation apparatus the enable owners or tenants to partially recover the energy from the exhaust gas and does not generate excessive back flow pressure that may damage the blowers would be highly desirable.

### SUMMARY OF THE INVENTION

Accordingly, these and other objects of the invention are met by an apparatus for generating electricity from a blower used to expel exhaust gases, fumes, dust, or hot air (hereinafter referred to as exhaust) from a piece of machinery located in a building. The apparatus is specifically designed to be used as an original installed equipment or installed as aftermarket or with retrofitted equipment with an existing exhaust handling equipment.

The apparatus includes a fan assembly and a generator assembly located inside a protective outer housing. In one embodiment, the outer housing is mounted on a hollow mounting base that acts not only as a support structure for the outer housing, but also as an exhaust air diverting structure that allows the operator to send the exhaust through the fan assembly and generator assembly or bypass the fan assembly and generator assembly altogether and expel the exhaust into the atmosphere. Attached to the base and mounted adjacent to the outer housing is a nozzle assembly. The nozzle assembly includes a conical-shaped tunnel that delivers exhaust to the outer housing and evidentially to the vanes on the fan assembly. Mounted inside the tunnel is a moveable gate that enables the operator control delivery of the exhaust to the outer housing or to a space located inside the base and evidentially to the atmosphere.

In another embodiment, the fan assembly and generator assembly are located inside a protective outer housing that includes a nozzle assembly with a bypass gate located therein. The bypass gate is designed to be fully open, fully closed or closed at 75%, 50% or 25%. The bypass gate is coupled to a programmed logic controller (referred to as a PLC) designed to control its open and closed position during operation. When the gate is closed, exhaust gas id diverted upward and away from the fan assembly. When the bypass gate is fully open, exhaust gas travels through the nozzle assembly and exists the end opening which is optimally aligned with the fan blades for maximum torque. During operation, the PLC is coupled to sensors that monitor exhaust velocity, the RPM's of the fan assembly, and door position. The angle of the bypass gate inside the nozzle tunnel is adjusted so that a maximum of energy is extracted at all times without placing undue backpressure on the piece of equipment.

In all the embodiments, the fan assembly includes a plurality of fixed vanes coaxially aligned around an axle located inside the outer housing. The opposite ends of the vanes are attached to two parallel side plates designed to rotate freely around the axle. During operation, the exhaust flows into the outer housing and perpendicular to the vanes thereby causing the fan assembly to rotate. Attached to inside side plate and coaxially aligned with the center axis of the fan assembly is a cylindrical outer casing of the generator assembly. By attaching the inside side plate to the outer casing, the fan assembly and the outer casing of the generator assembly rotate as one unit. Located inside the outer casing are two magnetic discs. The two magnetic discs are affixed to the opposite end walls of the outer casing and are spaced apart thereby forming a center gap. Each magnetic disc includes a plurality of permanent magnets radially aligned on a flat steel disc body. The magnets on each magnetic disc are aligned so that their polarity and opposite each other and face inward. The magnetic discs are oriented coaxially aligned around bearings mounted on a center axle that extends through the outer casing.

Located inside the center gap formed between the two magnetic discs is a stationary stator disc with a plurality of looped coil members radially aligned and embedded therein. There are three groups of looped coil members that are serially connected to form three alternating currents. When the stator disc is rotated in between the two magnetic discs, the three wires are then connected to the three groups of coil members and extend through to create a three phase A.C. electric current. The three wires can also be connected to a rectifier to create a D.C. current.

The apparatus also includes a control panel that includes a main disconnect switch, a rectifier, an inverter, and a load center that connects to an outside electrical power grid. The inverter includes electronics and a software program that allows the operator to adjust the amount of load on the generator so that the blower's operational base line measurements (electrical power usage (Watts), ductwork pressure differential, and exhaust gas velocity) are maintained.

### DESCRIPTION OF THE DRAWINGS

FIG. 1 is an illustration of an exhaust system used in the prior art.

FIG. 2 is a perspective view of the apparatus on a support frame positioned adjacent to the exhaust vent on a piece of machinery that produces a large volume of low velocity exhaust gas.

FIG. 3 is a side elevational view of the frame and the generator apparatus mounted therein showing.

FIG. 4 is a sectional top plan view of the apparatus shown the relative positive of the fan assembly and the generator assembly locator in the frame.

FIG. 5 is an exploded view of the generator apparatus.

FIG. 6 is a side elevational view of a side plate on the fan assembly showing the curvature and orientation of the vanes mounted on a side plate.

FIGS. 7 and 8 are side elevational views of the inside and outside side plates used on the fan assembly with the vanes removed.

FIG. 9 is a perspective view of the stator disc.

FIG. 10 is a partial, perspective view of the stator disc showing the relative position of the cooling disc and the outer windings.

FIG. 11 is a front elevational view of the first magnetic disc with the plurality of plate magnets radically mounted thereon with the north pole facing outward.

FIG. 12 is a front elevational view of the second magnetic disc with the plurality of plate magnets radially mounted thereon with the south pole facing outward.

FIG. 13 is an exploded perspective view of an optional transmission assembly disposed between the fan assembly and the generator assembly.

FIG. 14 is a flow chart showing the steps taken to utilize the electricity produced by the apparatus.

FIG. 15 is a perspective of the apparatus in which the fan assembly and generator are placed in an outer housing.

FIG. 16 is a side elevational view of the outer housing shown in FIG. 15.

FIG. 17 is a rear elevational view of the outer housing shown in FIG. 16.

FIG. 18 is a front elevation view of the outer housing shown in FIGS. 15-17.

FIG. 19 is a perspective of the outer housing shown in FIG. 14 with the muffler cover removed.

FIG. 20 is a top plan view of the apparatus shown in FIG. 19.

FIG. 21 is a perspective of the apparatus shown in FIG. 15 with the two side walls, the front end wall, the front solid top cover and top grid support removed.

FIG. 22 is a top plan view of the apparatus shown in FIG. 21.

FIG. 23 is a sectional side elevational view of the apparatus with the generator supporting strut removing showing the gate plate in a closed position.

FIG. 24 is a sectional side elevational view similar to the view shown in FIG. 23 showing the gate plate in an open position.

FIG. 25 is another embodiment of the apparatus in which the fan assembly and generator are placed in an outer housing with a muffler located around one end and bypass gate located inside the nozzle assembly designed to direct exhaust gas through or away from the outer housing.

FIG. 26 is a side elevational view of the apparatus shown in FIG. 25.

FIG. 27 is a front elevational view of the apparatus shown in FIGS. 25 and 26 with the bypass gate shown in a partially opened position inside the nozzle assembly.

FIG. 28 is a perspective of the apparatus shown in FIG. 25 with the outer cover and muffler removed showing the bypass gate in a closed position so that exhaust gas may enter the nozzle assembly and exit the rear narrow opening and cause the fan assembly to rotate.

FIG. 29 is a side elevational view of the apparatus shown in FIG. 28.

FIG. 30 is a front elevational view of the apparatus shown in FIGS. 28 and 29.

FIG. 31 is a side elevational view of the apparatus showing the bypass gate in a fully opened position and sequentially opened and showing the pathway of the exhaust gas upward and being diverted away from the fan assembly.

FIG. 32 is a side elevational view of the apparatus showing the bypass gate in a fulled closed position and allowing exhaust gas to flow through the narrow exit opening of the nozzle assembly and against the fan assembly causing it to rotate.

FIG. 33 is an illustration of the menu page generated the maximum power point tracking software program that is used to adjust the load on the generator assembly so that the blower operates within its baseline.

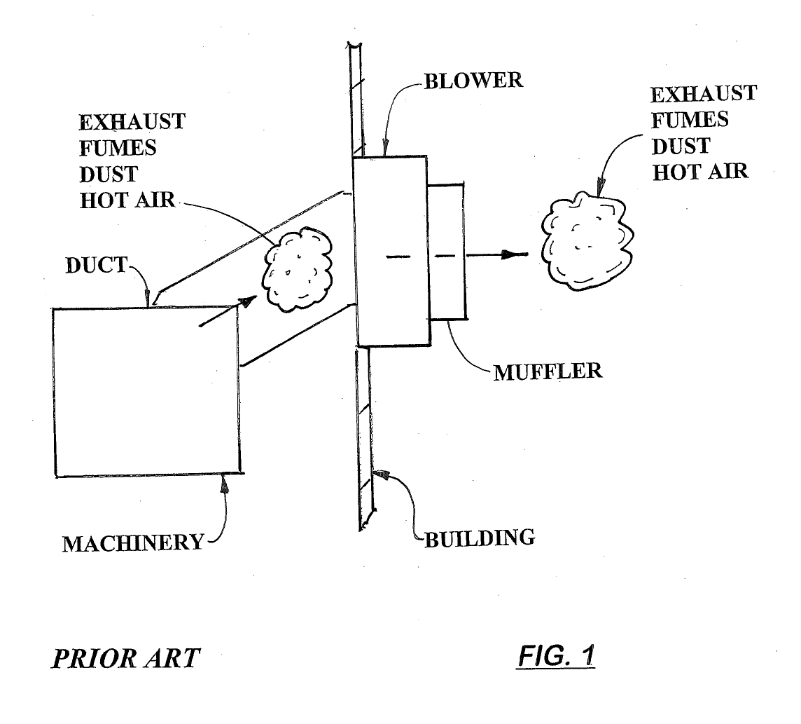

### DESCRIPTION OF THE PREFERRED EMBODIMENT(S)

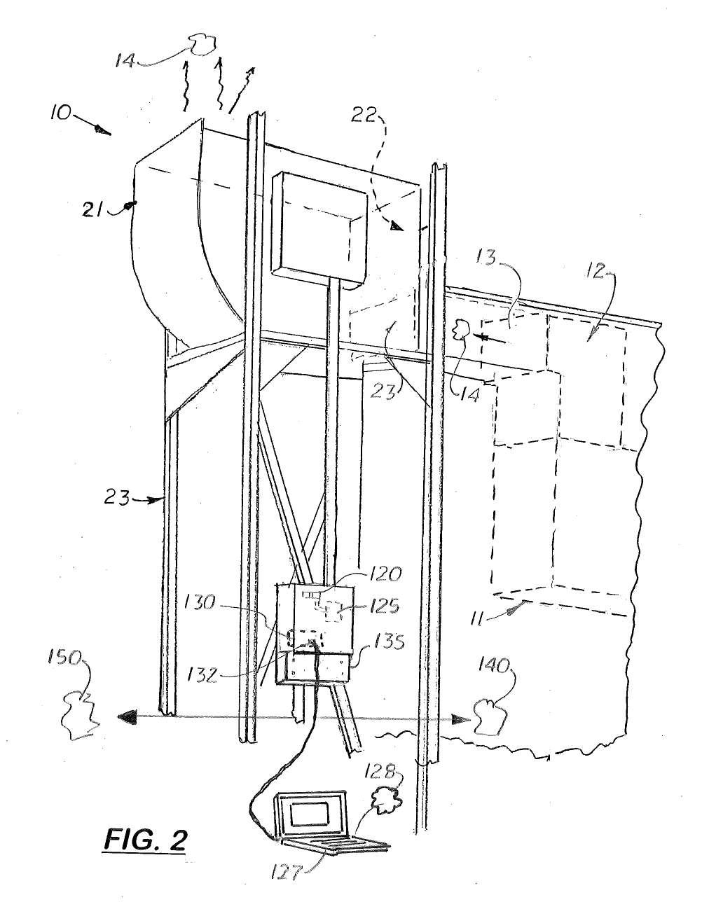

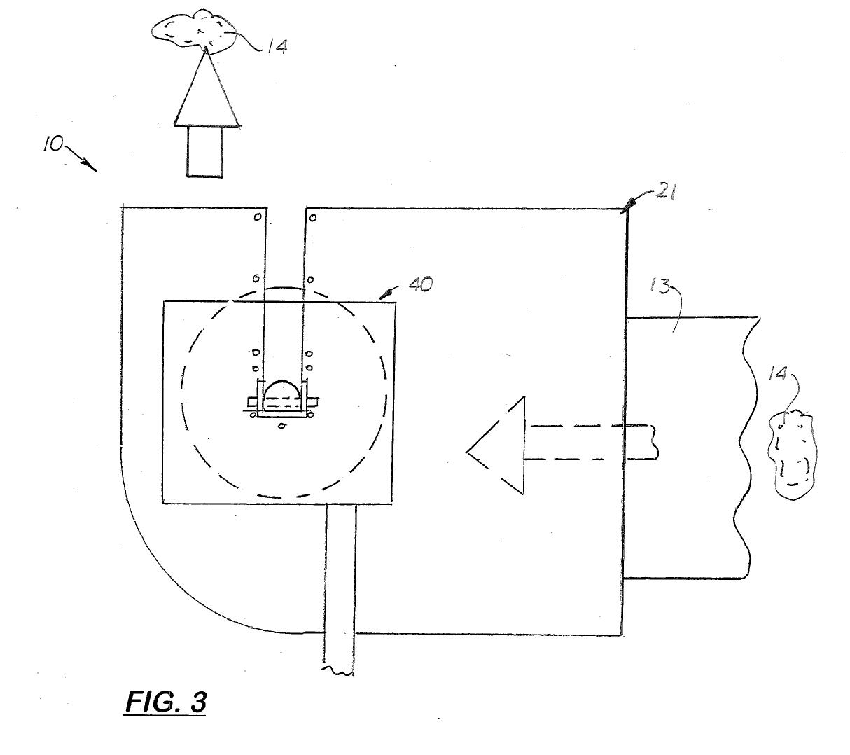

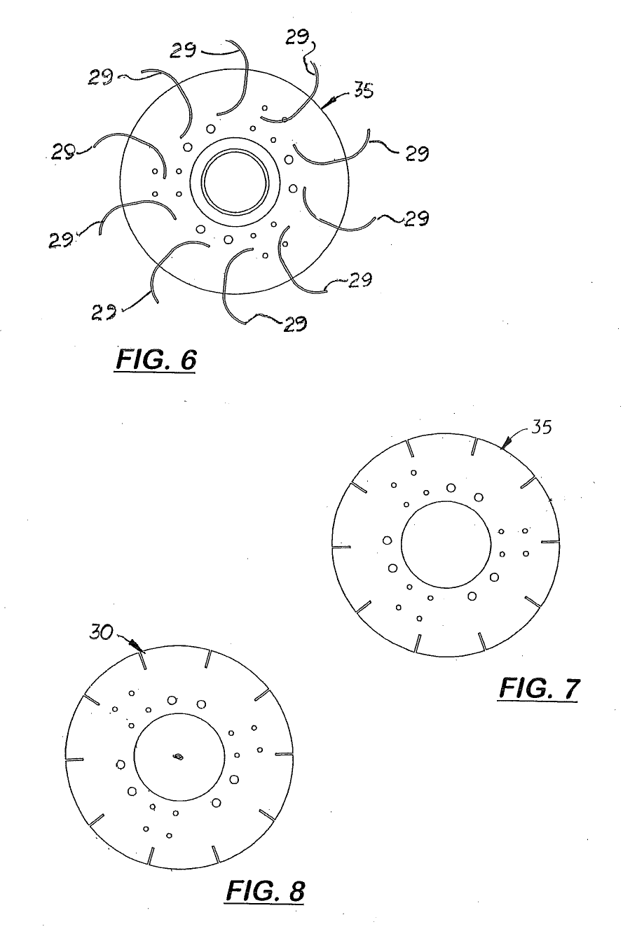

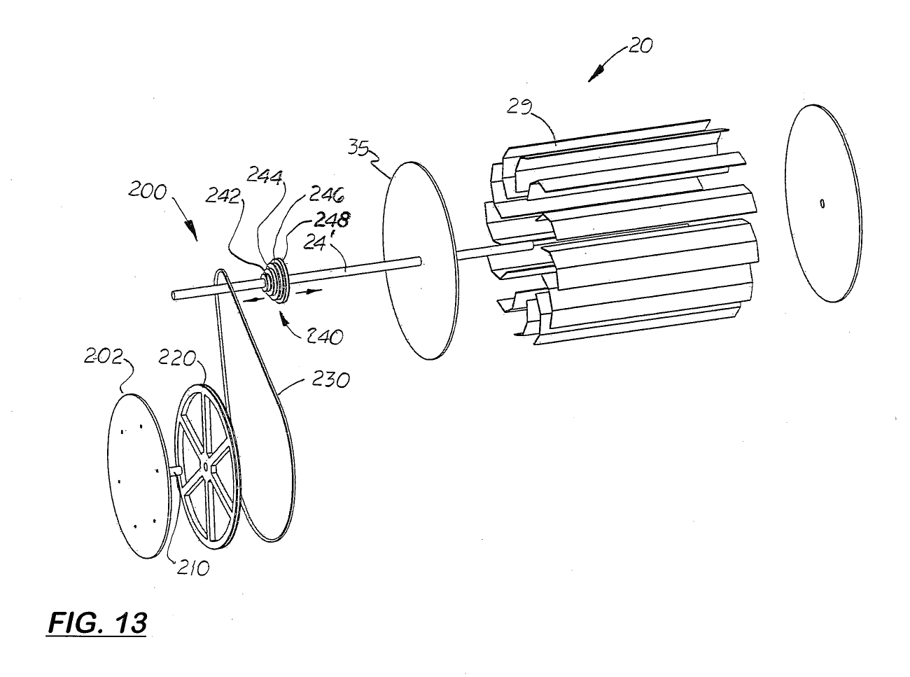

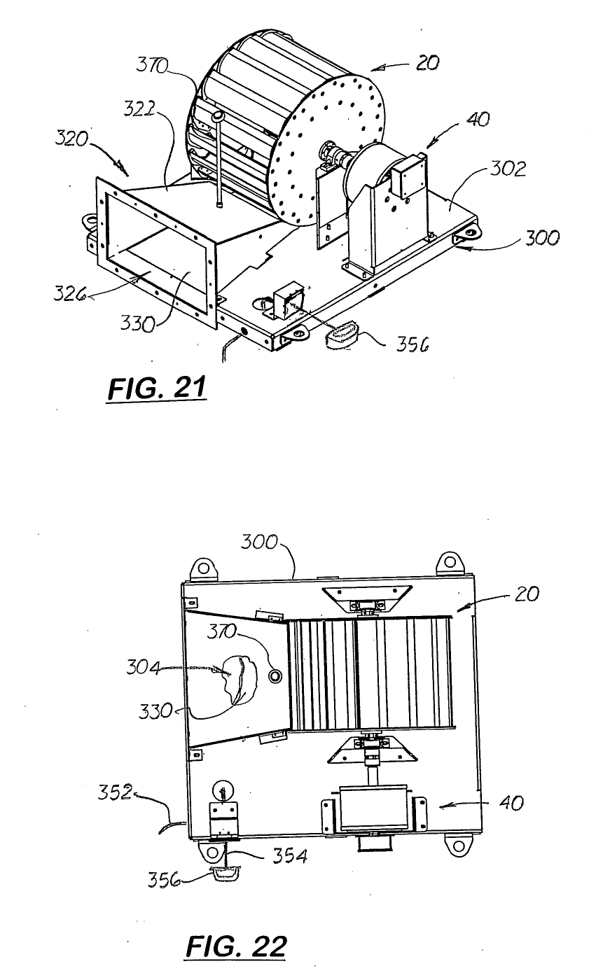

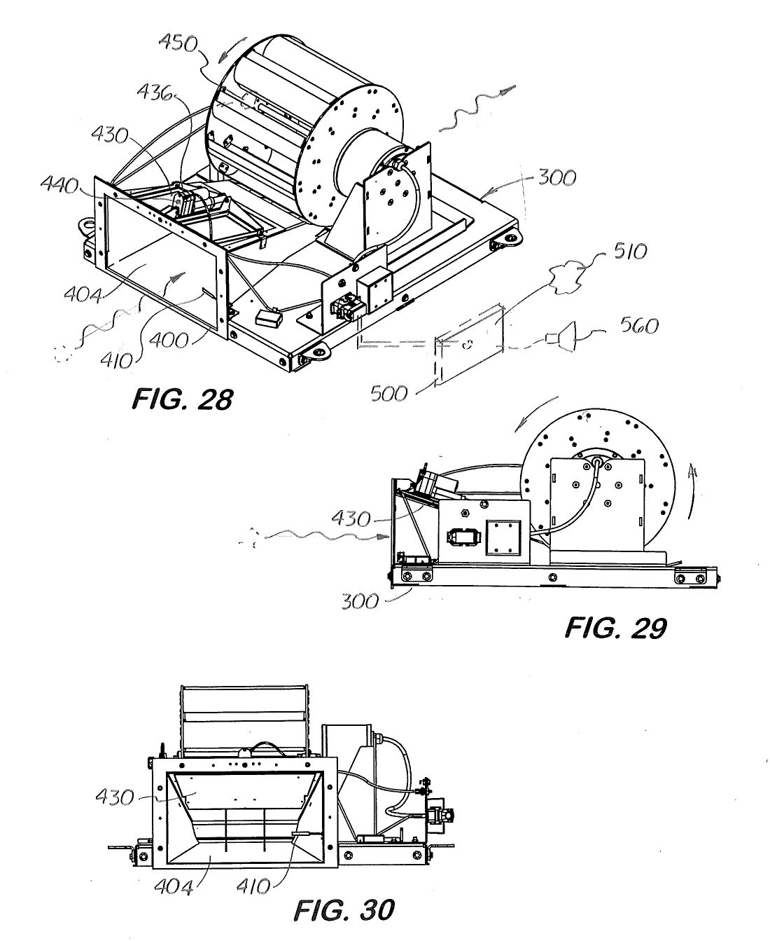

Referring to the FIGS. 2-32, an apparatus 10 for generating electricity from relatively low velocity exhaust 13 produced by a piece of machinery 11 is shown and described. The apparatus 10 includes a fan assembly 20 and a generator assembly 40 both located inside a rigid outer frame 21 mounted adjacent to the exhaust exit port 13 (or conduit) on a blower 12 used with a piece of machinery 11 located inside the building that produces exhaust 14. As discussed further below, the assembly 10 also includes a software program 400 loaded into a portable computer 390 that when connected to an inverter 130, presents a menu page 405 that allow the operator to adjust the load exerted by the generator assembly 40.

As shown in FIG. 2, the outer frame 21 may be mounted on a secondary support structure 23 that elevates the outer frame 21 so that the input opening 22 to the outer frame 21 is properly aligned with the exhaust port 13 on the blower 12.

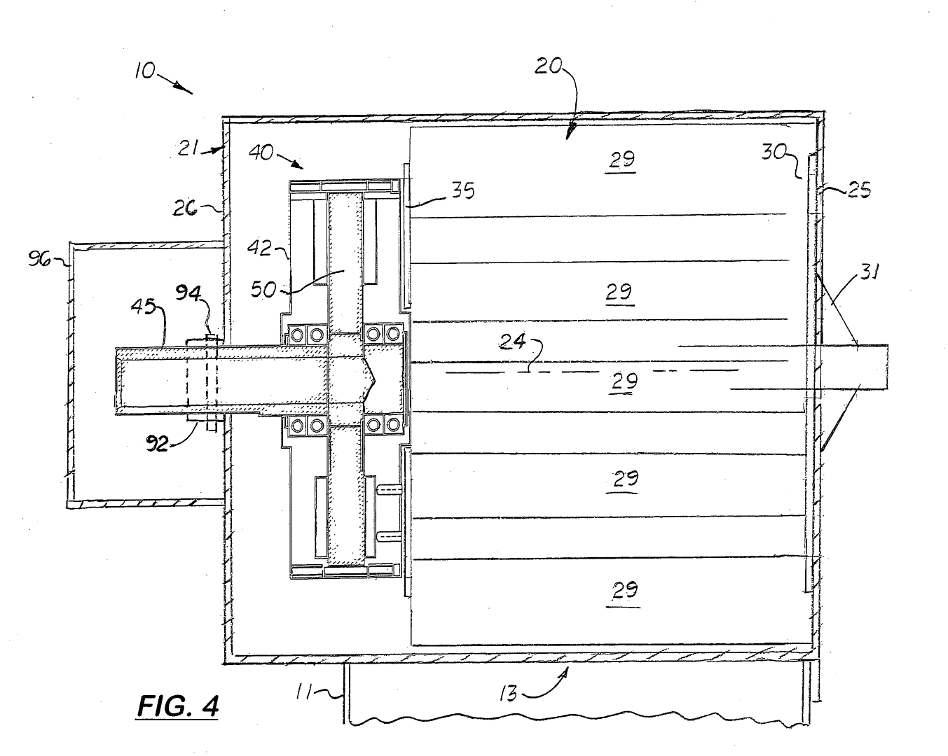

As shown in FIG. 4, the fan assembly 20 includes a plurality of fixed vanes 29 coaxially aligned around the outer frame's center axis 24. The vanes 29 which are rigidly attached to two circular side plates 30, 35 designed to rotate freely around the frame's center axis 24. In the preferred embodiment, the outside side plate 30 is mounted on a pillow block 31 located in a fixed position on the outside side wall 25 of the frame 21. The inside side plate 35 is securely attached to the inside plate 42A of the outer casing 42 of a generator assembly 40.

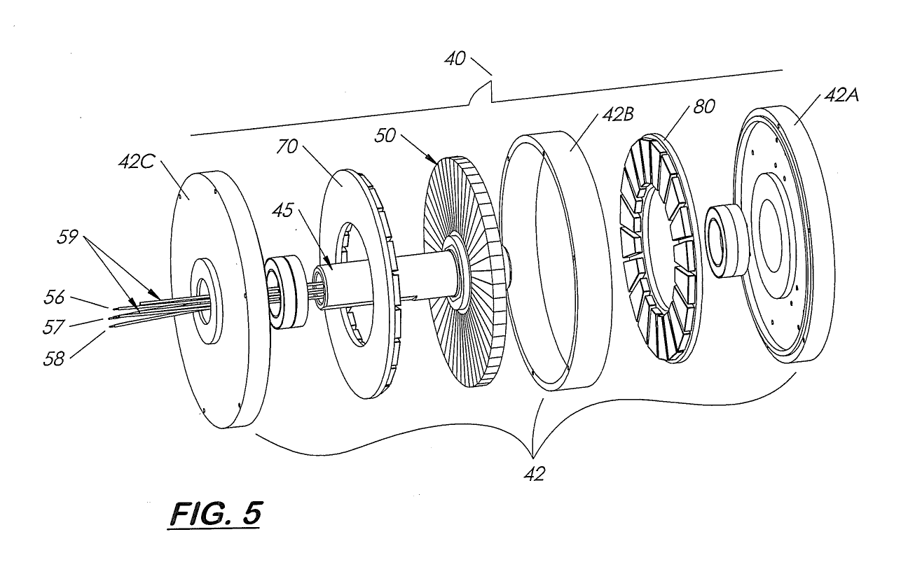

As shown in FIG. 5, the generator assembly 40 includes a stationary drive axle 45 that extends laterally from the fan assembly 20 and attaches to the inside side wall 26 of the outer frame 21. Rotatably mounted on the drive axle 45 and inside the outer frame 21 is a circular ring housing 42. The drive axle 45 is coaxially aligned with the outer casing 42 and longitudinally aligned with the fan assembly's center axis 24. As mentioned above, the inside side plate 35 on the fan assembly 20 is attached to the inside plate 42A of the outer casing 42 thereby enabling the fan assembly 20 and the outer casing 42 to rotate as one unit.

Mounted on the drive axle 45 and located inside the outer casing 42 is a flat stator disc 50 on which a plurality of coil track loops 52, 53, 54 are radially aligned. In the preferred embodiment, there are three types of coil track loops 52, 53, 54 that are alternately aligned on the opposite sides of the stator disc 50. The three types of coil track loops 52, 53, 54 are serially connected together by three wires 55, 56, 57 that extend through the drive axle 45. The ends of the three wires 55, 56, 57 extend through the end of the drive axle 45 that extends through the outside plate 42C of the ring housing 42 and connect to a rectifier 125 discussed further below. With three wires 55, 56, 57, a three phase A.C. electric current is created when the outer casing 42 is rotated around the stator disc 50.

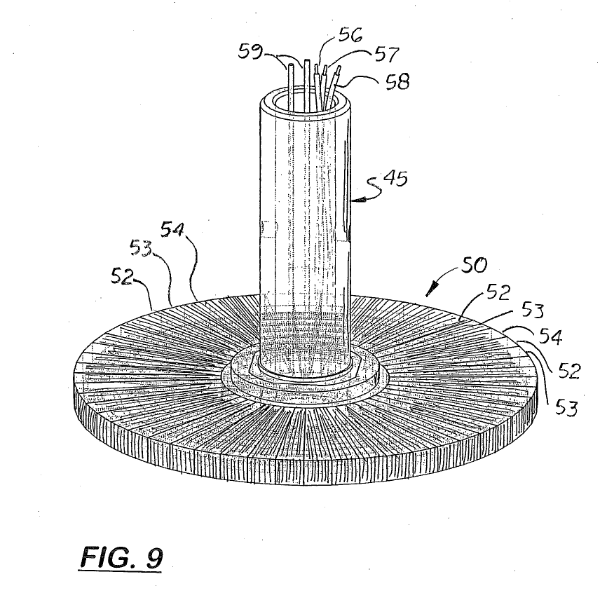

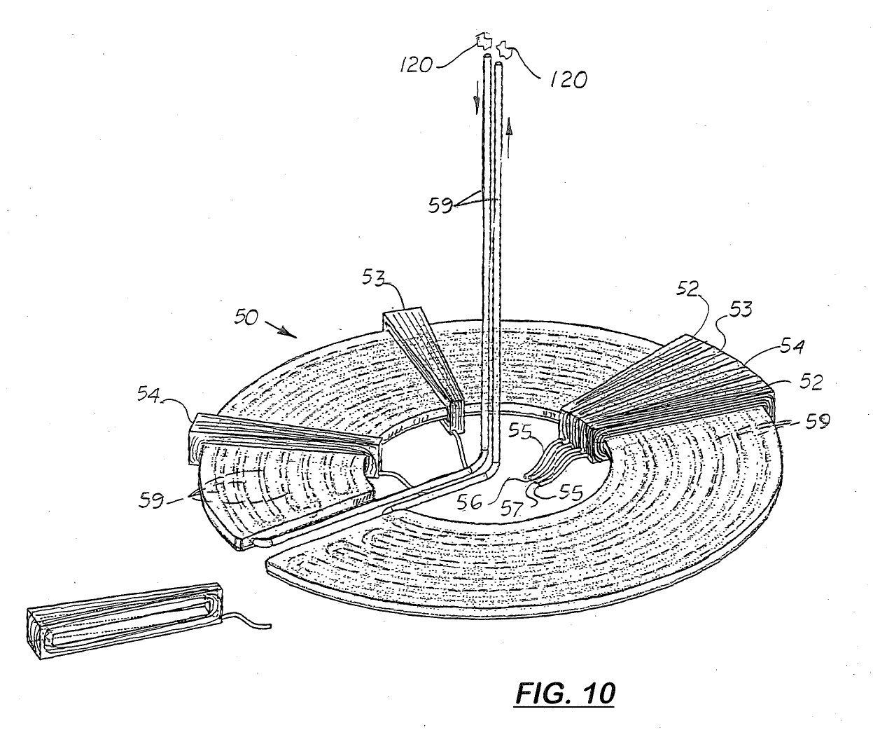

The stator disc 50 is made of non-metallic material such as fiberglass. Each coil track loop 52, 53, 54 is made of copper which is radially aligned in the stator disc 50 as shown in FIGS. 9 and 10.

During operation, the stator disc 50 becomes hot. To reduce heat an optional feature, a means for cooling the stator disc 50 may also be provided. In one embodiment, the means for cooling is a loop conduit 59 that is wound in a spiral configuration inside the stator disc 50 as shown in FIG. 10. During use, a coolant 120 flow continuously flows into the conduit 59 through the track loops 52, 53, 54 and then outward to a cooling radiator (not shown) to remove excess heat from the stator disc 50.

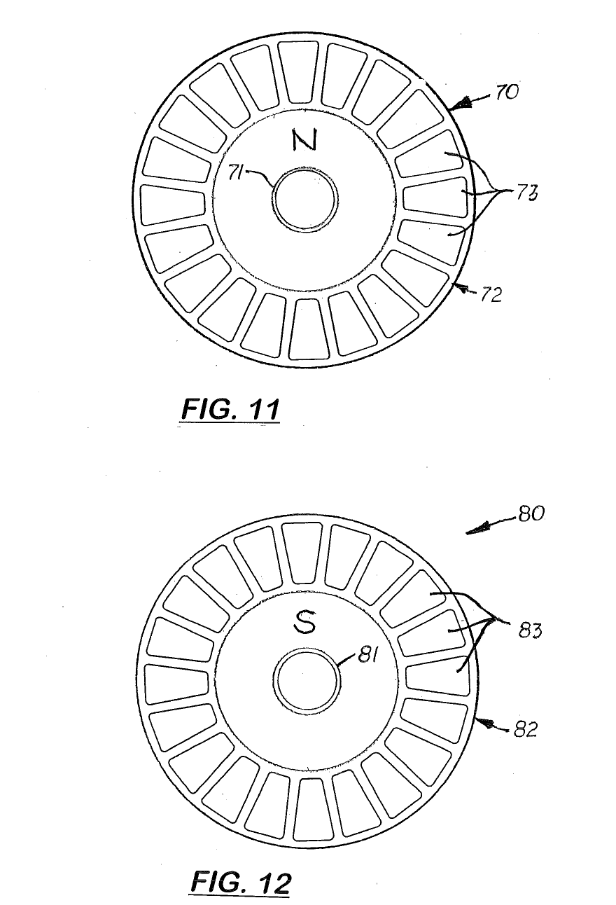

Also shown in FIG. 5, fixed to the inside surfaces of the two outside and inside plates 42C, 42A are two magnetic discs 70, 80, respectively. As shown in FIGS. 11 and 12, each magnetic disc 70, 80 includes a coaxially aligned bearing 71, 81, respectively, through which the drive axle 45 extends to keep the two discs 70, 80 centrally aligned inside the ring housing 42. Each magnetic disc 70, 80 includes a steel disc body 72, 82, respectively, with a plurality of charged magnet pads 73, 83, respectively formed on its inside surface. Magnet pads 73 of the first magnetic disc 70 all have a North magnetic charge while the magnet pads 83 of the second magnet disc 80 all have a South magnetic charge.

The outer frame 21, shown in FIGS. 2-4 is a partially enclosed, four sided box-shaped structure with two side walls 25, 26, a rear wall 27, and a bottom panel 28. Formed on each outside and inside side wall 25, 26 is a vertical slot 102 sufficiently wide to receive the drive axle 45 and pillow block, respectively. Welded to the outside side wall below the slot is a saddle bracket 105. During use, the distal of the drive axle 45 is placed into the slot 102 and over the saddle bracket 105. A pin 110 extends through a hole formed on the drive axle 45 and through holes formed in the saddle bracket 105 to hold the drive axle 45 in a fixed position on the place on the frame 21. Located over the outside side wall is a small dust cover 110.

FIG. 12 is a perspective view of an optional gear box assembly 200 disposed between the fan assembly 20 and the generator assembly 40 that enables the operator to selectively adjust the turning ratio between the fan assembly 20 and the generator assembly 40. The gear box assembly includes a flat plate 202 that's attached to inside plate 42A (not shown) on the generator assembly 40. Formed on the flat plate 202 is a stub 210 on which a large pulley 220 is affixed. Disposed around the pulley 220 is a belt 230 that extends around a multiple pulley hub 240 that is affixed to the end of an elongated axle 24′ attached to the fan assembly 20. The multiple pulley hub 240 includes a plurality of increasingly larger diameter pulleys 242, 244, 246, 248. During use, the multiple pulley hub 240 is moved to different positions along the axle 24′ so that the belt 230 may engage different diameter pulleys 242-248 on the pulley hub 240, the operator is able to adjust the rotation ratio of the fan assembly 20 to the generator assembly 40 so that electrical output is maximized and heat production is kept within normal limits.

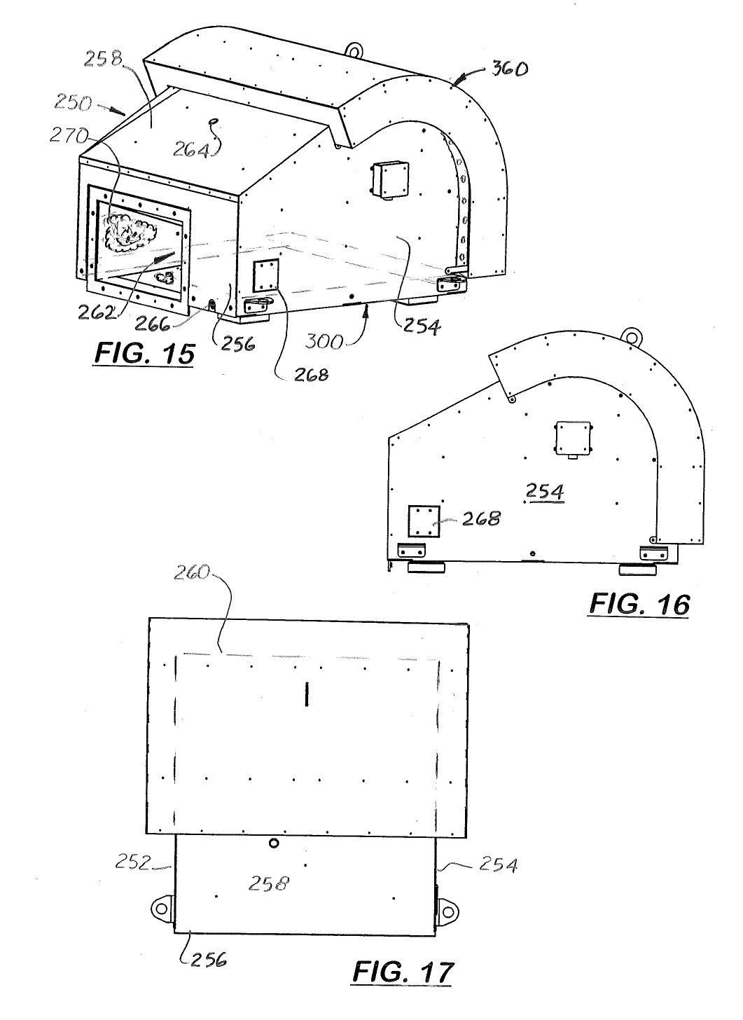

FIGS. 15-23 show a second embodiment of the apparatus 10′ that also uses a fan assembly 20 and generator assembly 40 located in a modified outer housing, generally indicated by the reference number 250. The outer housing 250 is mounted on a hollow mounting base 300 that acts not only as a support structure for the outer housing 250, but also as an exhaust diverting structure that allows the operator to send the exhaust 14 through the fan assembly 20 and generator 40 or to bypass the fan assembly 20 and generator assembly 40 altogether and expel the exhaust into the atmosphere. Attached to the base 300 and mounted adjacent to the outer housing 250 is a nozzle assembly 330. The nozzle assembly 330 includes a conical-shaped tunnel 340 that delivers exhaust 14 from the tunnel 340 to the fan assembly 20. Mounted inside the tunnel 340 is a moveable gate 350 that enables the operator control delivery of the exhaust 14.

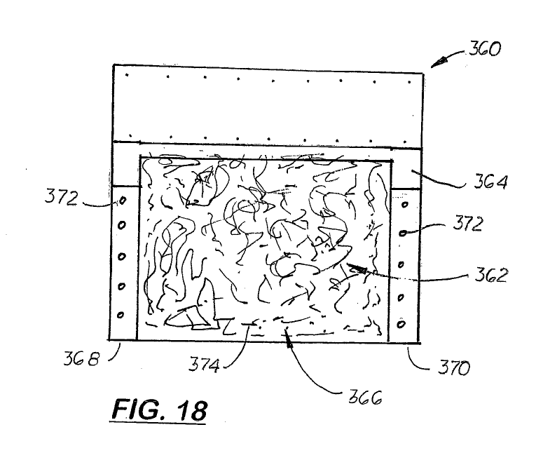

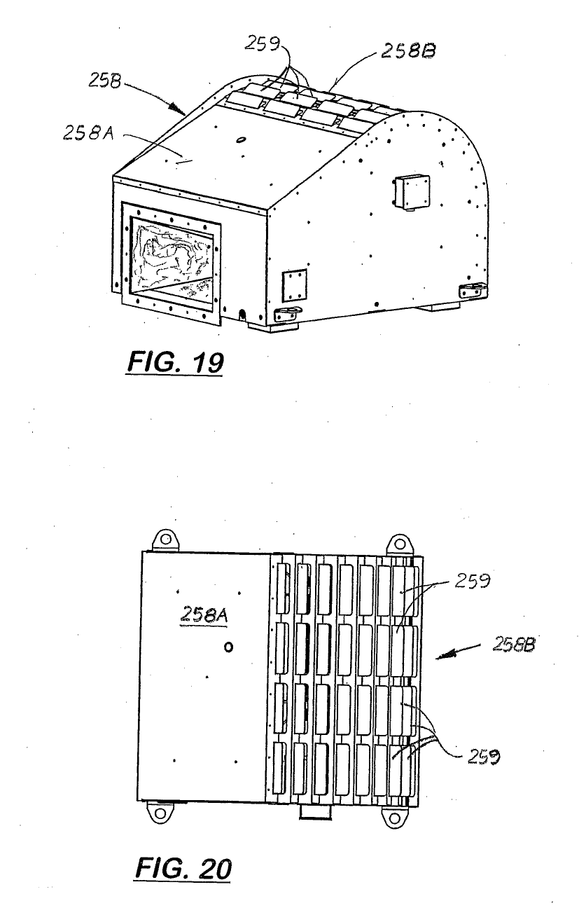

The outer housing 250 includes two side walls, 252, 254, a front wall 256, and a curved top 258 that bends around and forms a rear wall 260. Formed on the front wall 256 is a front opening 262. Formed on the top wall 258 is a push rod opening 264, a pull cord opening 266 and a pull handle plate 268. As shown in FIGS. 18 and 19, the curved top wall 258 includes a flat front section 258A and rear grate section 258B with a plurality of grate openings 259 formed thereon that are aligned diagonally rearward. Sprayed or attached to the inside surfaces of the side walls 252, 254 and the top 258 is optional, rubberized sound proofing material 270.

Mounted over the curved top is a muffler 360 that extends from the back surface of the fan assembly over the center axis of the top cover. The muffler 360 includes a hollow J-shaped body 360 with an inside opening 362 that extends over the back section of the fan assembly 20. The muffler 360 includes a closed front end wall 364 and open bottom 366. The muffler 360 is slightly wider than the outer housing 250 so that two equal size eaves 368, 370 are formed on the opposite sides of the muffler 360. A plurality of holes 372 are formed on each eaves 368, 370 that allows exhaust to escape from the outer housing 250. Formed or attached to the inside surfaces of the J-shaped body of the muffler 360 is acoustic lining 374.

During operation, exhaust 14 is delivered to the outer housing 250 and expelled through the fan assembly 20 and into the muffler 360. Once delivered to the muffler 360, the exhaust 14 is then expelled through the bottom opening 366 and the eave openings 372.

As shown in FIGS. 21-24, the base 300 is a square planar structure with a top plate 302 that partially covers the base 300 on which the outer housing 250, the fan assembly 20 and the generator assembly 40 are fixed. An opening is created on the base 300 that leads to a center area 304 under the top plate 302 that is unobstructed. Formed on the back surface of the base 300 is a rear opening 306 so that exhaust 14 directed to the center area 304 may escape from the base 300.

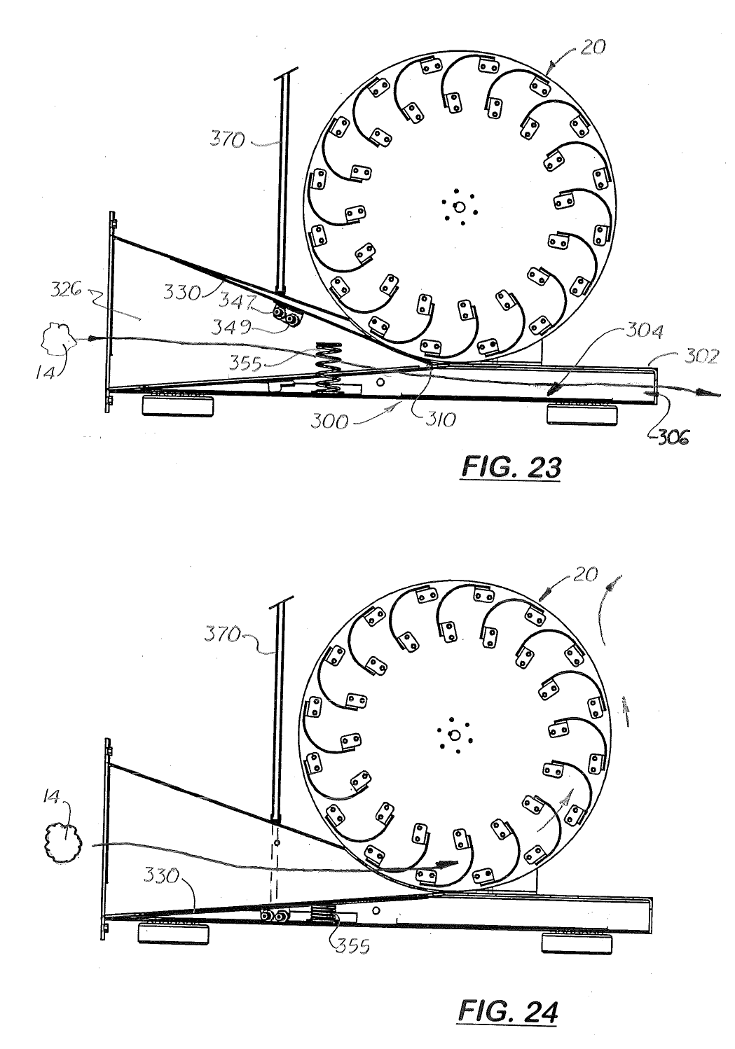

Mounted on the base 300 is a nozzle assembly 320 that includes a conical-shaped tunnel 321 with a pivoting gate 330 located therein. The tunnel 321 is affixed to the base 300 and the gate 330 is attached at its distal end to the base 300 or to the top plate 302 via a hinge 310. Formed on one end of the tunnel 321 is a large front opening 326 and formed on the opposite end is a small rear opening 323. Also formed on the floor of the tunnel 321 is a lower opening 327 that creates a passageway into the center area 304 located inside the base 300. Disposed between the base 300 and the gate 330 is at least one spring 335 which bias the gate 330 upward in the tunnel 321 as shown in FIG. 23.

Attached to the sides of the gate 330 is at least one peg assembly 345 that engages either a top bracket 346 or a lower bracket 348 attached to the inside surfaces of the tunnel's upper and lower walls. When the gate 330 is rotated up and down inside the tunnel 321, the peg assembly 345 selectively engages either the top bracket 346 or the lower bracket 348. The peg assembly 345 includes two side by side spring-loaded pegs 347, 349 that are biased outward. The front peg 347 is attached to a release cord 352 and the rear peg 349 is attached to a locking cord 354. The two brackets 346, 348 are aligned on the two upper and lower walls of the tunnel 321 so that when the release cord 352 is pulled, the two pegs 347, 349 disengage from the lower bracket 348 thereby enabling the spring 335 to automatically rotate the gate 330 upward in a ‘closed’ position as shown in FIG. 23. The end of the locking cord 354 is connected to a handle 356 that is stored inside the handle box 268. When the handle 356 is removed from the box 268 and pulled, the back peg 349 is released from the top bracket 348 on the top surface of the tunnel 321 thereby enabling the operator to manually pull the gate 330 downward and allow exhaust to rotate the fan assembly 20. Because the front tunnel opening 362 of the tunnel 321 is not accessible, a push rod 370 that is attached to the top surface of the gate 330 that extends through a pull rod hole formed on the tunnel 321 that allows the operator to push the gate 330 downward inside the tunnel 321.

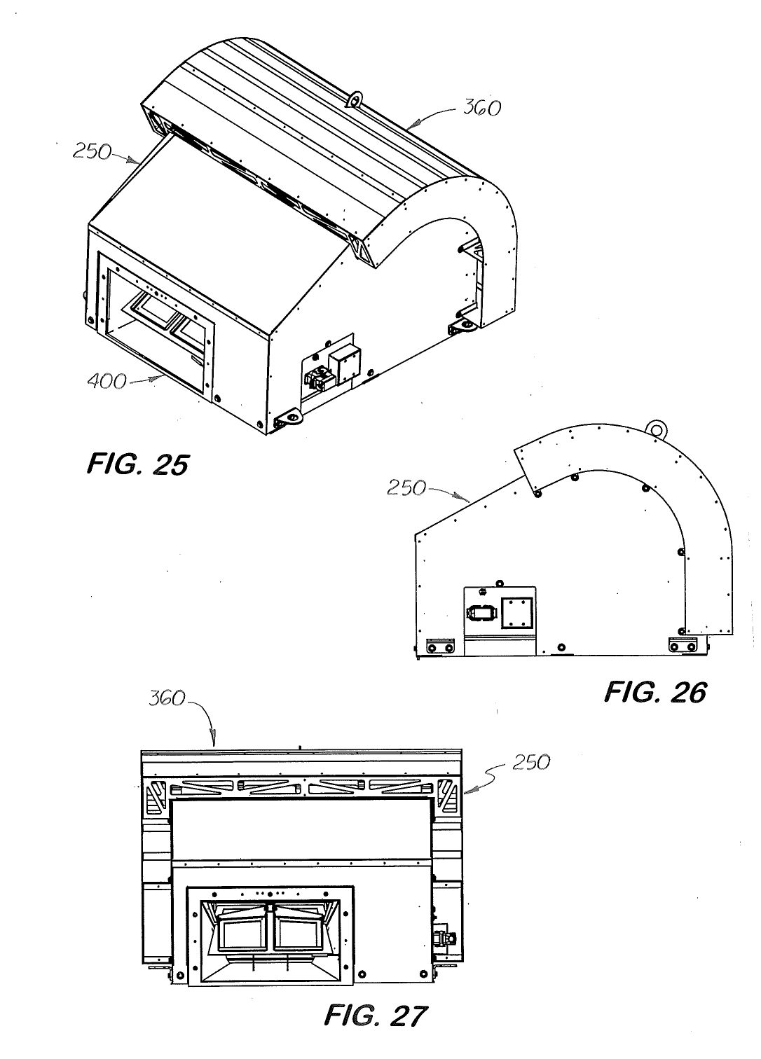

FIG. 25 is another embodiment of the apparatus 10″ in which the fan assembly 20 and generator assembly 40 are placed inside an outer housing 250 with an option muffler 360 located over oen end. The outers housing 260 includes a nozzle assembly with a conical shaped tunnel. The tunnel includes a wide front opening a narrow rear opening. Formed on the top surface of the tunnel is a large air vent. Disposed inside the tunnel is a pivoting bypass gate 430. The bypass gate 430 is sufficient in size to close the tunnel when moved on an open position and close the air vent opening on the top surface of the tunnel when moved to an open position. The bypass gate 430 is connected to a solenoid 435 that includes a plunger arm that connects to the top edge of the bypass gate. When the plunger are is extended or retracted, the bypass gate moves to an closed or open position, respectively.

Apparatus 10″ is designed to monitor the flow of exhaust gas delivered from the piece of machiney, gradually adjust the production of energy from the generator during the initial startup phase, optimize the extraction of energy, and than allow the exhaust gas to bypass the apparatus 10″ during maintenance so that the piece of equipment may continue to operated

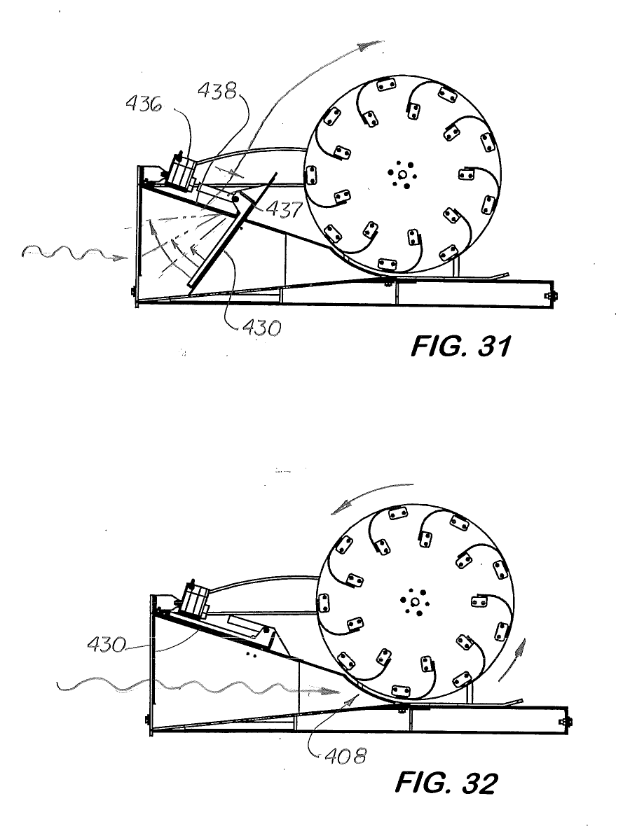

The bypass gate 430 is designed to be fully open, fully closed or closed at 75%, 50% or 25%. The bypass gate 430 is coupled to a programmed logic controller (referred to as a PLC 500) designed to control the bypass gate's 430 position inside the tunnel. When the by pass gate 430 is opened as shown in FIG. 31, exhaust gas enters the tunnel and then directed upward through the air vents 428 and away from the fan assembly 20. When the bypass gate is fully closed, as shown in FIG. 32, exhaust gas travels through the tunnel and exists the narrow end opening. The end opening is optimally aligned with the fan blades for maximum torque. Located on the front opening of the nozzle is a sail switch 410 designed to measure the velocity of the exhaust gas. Attached to the solenoid is a second switch 440 that measures the position of the bypass gate 430. Attached to the plate on the fan assembly 20 is a third sensor 450 that measures the RPMs of the fan assembly 20. The three sensors 410, 440, 450, are coupled to a programmable PLC 500 so that the output from all three sensors 410, 430, 450 are constantly monitored. When an undesirable measurement is obtained or the apparatus 10″ is determined not to be operating optimally, a signal from the PLC 500 is sent to the solenoid 436 causing the bypass gate 430 to open or close. The PCL 500 is controlled by a software program 510 that enables the user to program the desired sensor setting depending on the exhaust gas velocity and the size of the generator assembly 40.

At startup, the inverter 600, discussed further below, must be initialized. During start up, the exhaust sensor 410 detects air flow through the nozzle assembly and begins to monitor the exhaust air velocity the fan assembly's RPM via the sensor 450, and the bypass gate's position via sensor 440. The bypass gate 430 is initial position is programmed to be at a relatively low setting that allows for sufficient exhaust gas to enter the nozzle and cause the fan assembly 20 and the generator assembly 40 to rotate and initialize the inverter 600. During this initial stage, too much exhaust gas can create high voltage from the generator assembly that can cause damage to the assembly 10″. Too little exhaust gas, will not allow the inverter 600 to initialize.

Once the inverter 600 has been initialized and the generator assembly 40 begins to extract energy, resistance builds gradually builds in the apparatus 10″ which causes the fan assembly 20 to slow down. The PLC 500 detects the lower RPM's and incrementally begins to close the bypass gate 430 which optimizes energy production will little or no increase in back pressure on the piece of machinery. The PLC 500 may fully close or fully open the bypass gate.

All sensors 410, 440, and 450 have minimum and maximum limit settings. The exhaust gas sensor 410 will not be activated unless there is sufficient flow through the nozzle assembly. When no flow is detected, PLC 500 and the second sensor 440 is activated and the bypass gate 430 automatically return to their startup positions. The RPM sensor 450 sends data to the PLC 500 which as tiered settings and can also be linked to a specific time duration. When it reaches the first tier setting, it holds and waits for a decrease in RPMs (inverter initialization), the time settings can be programmed for any duration that optimizes the system. The system then proceeds through the settings until the bypass gate 430 has reached its programmed position. If the RPM sensor 450 detects excessive RPMs, the PLC 450 automatically closes the bypass gate and signals and audible alarm 560.

In all embodiments, during operation the rotation of the fan assembly 20 by the flow of exhaust 14 through the fan assembly 20 causes the two discs 70, 80 located inside the outer housing 42 to rotate around the stator disc 50. As the two discs 70, 80 rotate around the stator disc 50, a three phase A.C. electric current is produced in the stator disc 50 which is then transferred via the three wires 55, 56, 57. The three wires 55, 56, 57 are connected to a rectifier 130 that modules and converts the A.C. current into a D.C current. After converted into D.C. current, the current is then delivered to an inverter 140 which re-converts the D.C. current into A.C. current which can then be used or transmitted to a utility electric grid 150.

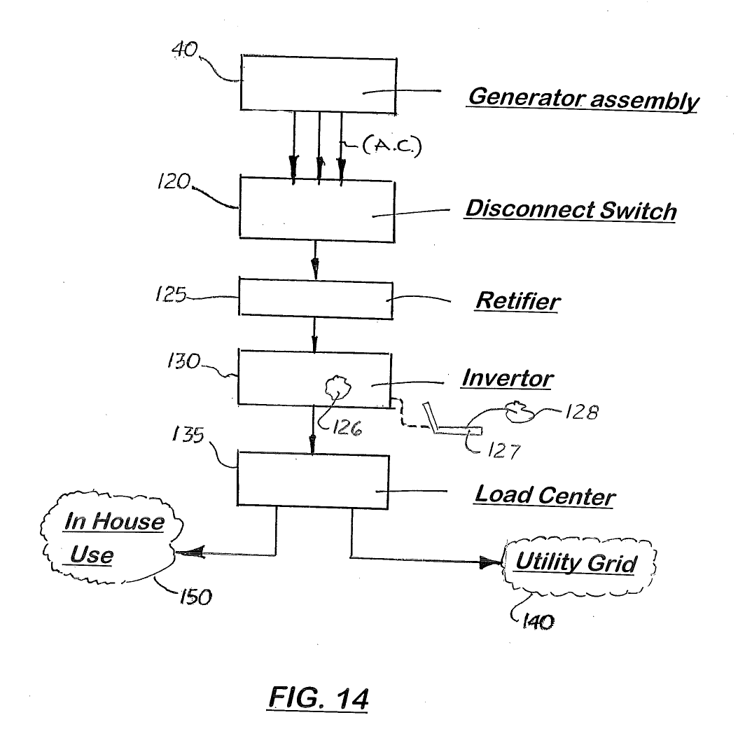

FIG. 14 is a flow chart that shows how the apparatus' generator assembly 40 is connected is a utility grid 140 or to the building electrical system 150. The generator assembly 20 connected to a disconnect switch 120. The rectifier 125 is connected to an inverter 130. The inventor 130 is connected to a load center 135 which then delivers the A.C. current produced by the generator assembly 40 to either the utility grid 140 or to the building' electrical system 150.

The inverter 125 includes electronics (hardware) 126 and a software program 128 that allows the operator to adjust the amount of load on the generator assembly 40 so that the blower's 12 operational base line measurements (electrical power usage (Watts), ductwork pressure differential, and exhaust gas velocity) are maintained. If the apparatus 10 is installed into an existing blower exhaust system, prior to removing the old muffler and duct work, an energy audit of the old system if first conducted. During the energy audit, the amount of electrical energy the blower motor uses, the velocity of the exhaust as it leaves the blower, and the duct pressure are measured. These three parameters provide a baseline for the old blower 12. The load on the generator assembly 40 is then adjusted to that the baseline is obtained.

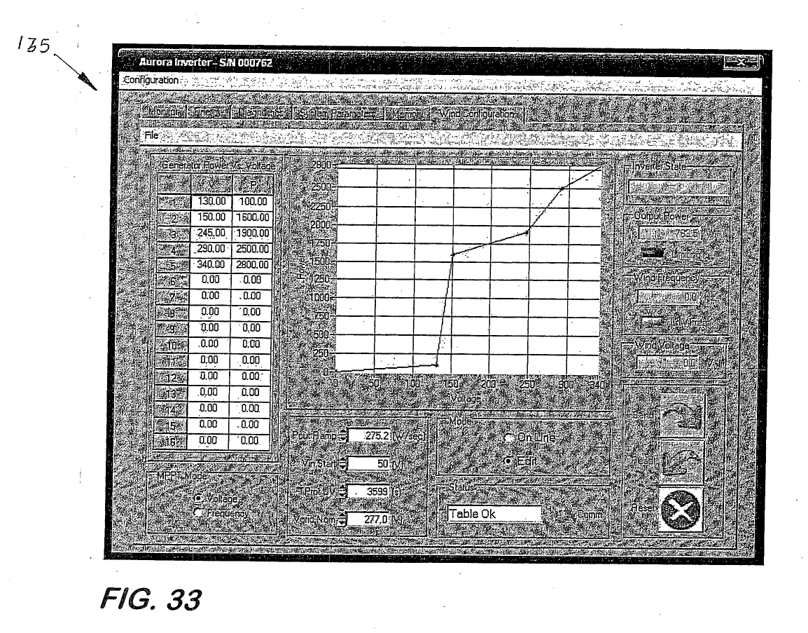

After the energy audit is conducted, a portable computer (i.e laptop) 127 with a maximum power point tracking software program 128 (known as a MPPT software program) loaded into its memory. Such programs are commonly available through companies that manufacture electrical inverters. The portable computer 127 is then connected to a communication port 132 on the inverter 130. The software program 128 is then executed and the electrical power, velocity and pressure differentials are then inputted to the portable computer 127. The software program 128 generates the menu page 135 shown in FIG. 33. The operator then uses the software program 128 to adjust the amount of load exerted by the inverter so that the blower 12 operates most efficiently.

The outer housing 21, may be made of sheet metal or aluminum. The ring housing 42 used with the generator assembly is made of non-ferric material, such as aluminum. The two rotating magnetic discs 70, 80 are made of ferric material, such as steel. The stator disc 50 is made of a plurality of coil track loops 52, 53, 54 embedded in a thin disc made of lightweight insulation material, such as fiberglass. The vanes 29 may be made of light weight metal, fiberglass, plastic or fabric.

Using the above described apparatus, a method for generating electricity from the exhaust produced by a blower, comprising the following steps:

a. selecting a piece of machinery with a blower that produces exhaust delivered through an exhaust vent;

b. selecting an exhaust gas electricity generator system that includes an outer housing that contains a fan assembly and a generator assembly coupled thereto, said outer housing mounted on a hollow base that includes a nozzle assembly with a pivoting gate that enables exhaust to be selectively delivered to said fan assembly, said fan assembly includes two rotating discs and a plurality of vanes connected at their opposite ends to said discs, said fan assembly being mounted over the exhaust opening so that said vanes are aligned transversely to the direction of flow of the exhaust gas, said generator assembly including an outer housing with two magnetic flat discs surrounding a flat center stator disc, said stator disc includes a plurality of coil members in which an electric current is created when said magnetic discs are rotated around said stator discs;

c. mounting said exhaust gas electricity generator system over said exhaust vent so that the exhaust flows into said nozzle assembly;

d. controlling said gate inside said nozzle assembly to deliver exhaust to said fan fan assembly;

e. connected said generator assembly to an electricity distribution system; and,

f. activating said blower produce exhaust that is converted into electricity.

Before installing the above system, a baseline energy audit may be conducted on the blower. A laptop computer with a maximum power point tracking software program loaded into its memory may be attached to the inverter which is then used to adjust the load level of the generator assembly so that the blower may operate optimally.

In compliance with the statute, the invention described herein has been described in language more or less specific as to structural features. It should be understood however, that the invention is not limited to the specific features shown, since the means and construction shown is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. An apparatus for generating electricity from relatively low velocity exhaust gas produced by a piece of machinery, said piece of machinery includes an exhaust port through which exhaust gas is expelled, said apparatus includes:
a. a hollow outer housing;
b. a base located under said outer housing;
c. a fan assembly mounted on said base and under said outer housing, said fan assembly includes a plurality of fixed vanes coaxially aligned inside said frame axel connected at their opposite ends to two rotating side plates;
d. a low RPM generator coaxially aligned and attached said fan assembly, said generator includes a cylindrical outer housing attached to at least one said rotating side plate on said fan assembly, said generator includes a center axle with a stationary stator disc aligned therewith, said stator disc including a plurality of coil members radially aligned and embedded therein, said coil members being serially connected together with wires that extend into said drive axle, said generator also including two magnetic discs located inside said outer housing and coaxially aligned with said stator disc, each said magnetic disc having a plurality of magnets mounted on its inside surface, said magnets on said magnetic disc having opposite polarities so that when said fan assembly rotates, an electric current is produced in said stator disc;
e. a nozzle assembly mounted on said base and extending into said outer housing, said nozzle assembly includes a tunnel with a front opening and a rear opening, said rear opening being tangentially aligned with said fan assembly;
f. a bypass gate transversely aligned inside said tunnel, said closeable gate able to rotate within said tunnel thereby simultaneously controlling the cross-sectional area and the path of exhaust gas that flows into said fan assembly;
g. means for controlling the position of said closeable gate in said tunnel;
h. an inverter connected to said generator; and,
i. a maximum power point track software program used to control the electrical load on said generator assembly.

2. The apparatus, as recited in claim 1, further comprising a means for cooling said stator disc.

3. The apparatus, as recited in claim 2 wherein said means for cooling said stator disc is a cooling disc disposed within said stator disc filled with a re-circulated liquid coolant.

4. The apparatus, as recited in claim 1, wherein said stator disc includes a plurality of coil windings divided into three groups, said groups being alternatively arranged over said stator disc, said coil windings in each group being serially connected together so that an A.C. current is produced from said generator assembly.

5. A method for converting exhaust air from a piece of machinery into electricity comprising the following steps:
a. selecting a piece of equipment that produces exhaust and delivers it through an exhaust vent;
b. selecting an exhaust gas electricity generator apparatus that includes an outer housing that contains a fan assembly and a generator assembly coupled thereto, said outer housing mounted on a hollow base that includes a nozzle assembly with a pivoting bypass gate that enables exhaust to be selectively delivered to said fan assembly, said gate being transversely aligned inside said nozzle assembly so that the cross-section area of the exhaust gas may be adjusted the direction of the stream of exhaust gas that exits said nozzle assembly is controlled, said fan assembly includes two rotating discs and a plurality of vanes connected at their opposite ends to said discs, said fan assembly being mounted over the exhaust opening so that said vanes are aligned transversely to the direction of flow of the exhaust gas, said generator assembly including an outer housing with two magnetic flat discs surrounding a flat center stator disc, said stator disc includes a plurality of coil members in which an electric current is created when said magnetic discs are rotated around said stator discs;
c. mounting said exhaust gas electricity generator apparatus over said exhaust vent so that the exhaust flows into said nozzle assembly;
d. controlling said gate inside said nozzle assembly to adjust the cross-sectional and path of exhaust that flows through said nozzle assembly to said fan fan assembly;
e. connected said generator apparatus to an electricity distribution system that includes a rectifier and an adjustable inverter; and,
f. activating said piece of machinery to produce exhaust that is converted into electricity.

6. The method as recited in claim 5, further including the step (g) of adjusting said inverter so that the load created by said generator assembly enables said blower to operate within its optimal baseline.

7. The method as recite in claim 6, wherein the step (g) of adjusting said inverter is performed by a portable computer with a maximum power point tracking software program loaded therein, said portable computer being connected to said inverter.
